(19) United States
(12) Patent Application Publication
(10) Pub. No.: US 2002/0062390 A1
(43) Pub. Date: May 23, 2002

(54) Switch control system and switch control method for communication apparatus

(76) Inventors: Takeshi Tajima, Ome-shi (JP); Kazuo Fukaya, Ome-shi (JP)

Correspondence Address: Finnegan, Henderson, Farabow, Garrett & Dunner, L.L.P., 1300 I Street, N.W., Washington, DC, 20005-3315, US

(21) Appl. No.: 09/987,615

(22) Filed: Nov. 15, 2001

(30) Foreign Application Priority Data
Nov. 17, 2000 (JP) 2000-351608

(51) Int. Cl. G06F 15/173

(52) U.S. Cl. 709/244

(57) ABSTRACT

A control system which is capable of selectively using any of a plurality of communication devices. When an operator selects a desired communication device from a plurality of communication devices, state information concerning each of the communication devices is rewritten so as to render only the selected communication device usable. The control system uses properties of the OS to temporarily stop all the communication devices, and thereafter controls only the selected communication device usable in accordance with the changed state information.

### CROSS-REFERENCE TO RELATED APPLICATIONS

This application is based upon and claims the benefit of priority from the prior Japanese Patent Application No. 2000-351608, filed Nov. 17, 2000, the entire contents of which are incorporated herein by reference.

### BACKGROUND OF THE INVENTION

1. Field of the Invention

The present invention relates to a control system and a control method for statically or dynamically switching and controlling a communication device included in a personal computer or the like.

2. Description of the Related Art

Normally, an electronic device such as a personal computer (hereinafter called a “PC”) or the like can be connected with various communication devices. Those various communication devices are included in or externally attached to a PC or the like, and are statically or dynamically managed by control functions of the operating system (hereinafter called “OS”) of the PC or the like.

There is a case that a user makes data communication in an environment in which a plurality of communication devices are thus connected with a PC. In this case, which communication device is used to make the communication is determined by a routing table included in the PC or the like. Therefore, if the user desires to use a communication device different from the communication device determined by the routing table, the contents of the routing table need to be changed and updated.

However, management of the routing table is very difficult and complicated in general. If an ordinary user changes and updates the contents of the routing table to carry out switching and control of communication devices, operationality and rapidness are lost unsuitably for practical use.

In addition, a conventional PC or the like is not provided with a hardware or software function to switch communication devices in correspondence with the situation.

The present invention has been made in view of the above situation and has an object of providing a system and a method for switching communication devices, which are capable of easily executing switching between electronic devices at low costs and hence improving the handling of a computer or the like, without asking a user to make difficult or complicated state of communication devices.

### BRIEF SUMMARY OF THE INVENTION

According to the first aspect of the present invention, there is provided a communication device switching control system comprising: a plurality of communication devices; a memory configured to store operational state information concerning each of the plurality of communication devices; a selection device configured to select a desired one of the plurality of communication devices; a state information administrative device configured to set up usable with respect to operational information of the selected communication device, and to store the setting operational state information to the memory; and

a controller configured to control the selected communication device, in accordance with the setting operational state information stored in the memory.

According to the second aspect of the present invention, there is provided a communication device switching control method comprising steps of: selecting a desired one of a plurality of communication devices; setting up usable with respect to operational information of the selected communication device; storing the setting operational information to a memory; and controlling each of the communication devices in accordance with the setting operational information in the memory.

According to the third aspect of the present invention, there is provided a communication device switching control system comprising: a plurality of communication devices; a memory configured to store state information concerning each of the plurality of communication devices; a first computer code device configured to select a desired one of the plurality of communication devices; a second computer code device configured to set up usable with respect to operational information of the selected communication device, and to store the setting operational state information to the memory; and controller for controlling each of the communication devices, in accordance with the setting operational state information stored in the memory.

Functions and structures of electronic devices in recent years are very complicated. If switching between these electronic devices is realized by connection switching based on hardware, it costs very much and is therefore not suitable for practical use.

If the switching between electronic devices is realized by software, a user is forced to make very complicated operation. In particular, operation of switching from a static state to a dynamic state requires a very high technique.

In contrast, the communication device switching control system or method having the structure as described above is constructed in a structure in which a standard function provided by a very simple interface and OS is utilized to carry out switching between electronic devices.

Thus, according to the present communication device switching control system or method, a user can execute easily switching between electronic devices at low costs without making difficult and complicated state of communication devices. As a result, the handling ability of the computer or the like can be improved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of a computer system comprising a communication device switching control system according to the embodiment;

FIG. 2 is a block diagram showing the communication device switching control system;

FIG. 3 is a flowchart showing a procedure of a communication device switching operation which is executed by the communication device switching control system;

FIG. 4 is a view showing an example of selecting a communication device with the use of the GUI (Graphical User Interface);

FIG. 5 is an explanatory view of a communication device switching operation which is executed by the communication device switching control system; and

FIG. 6 is an explanatory view of a communication device switching operation which is executed by the communication device switching control system.

### DETAILED DESCRIPTION OF THE INVENTION

An embodiment of the present invention will be explained with reference to the drawings. The following explanation deals with an example of a communication device switching control system constructed in a computer system comprised of a personal computer (hereinafter called a “PC”) or the like and a communication-device connected with the PC. However, the communication device switching control system according to the present invention is not limited to the present invention but is applicable to a system comprised of a network appliance or an electronic device such as a portable phone or the like and a plurality of communication devices.

In the following explanation, those components that have a substantially similar function and a substantially similar structure will be denoted by the same reference symbols, and an explanation thereof will be repeated only if necessary.

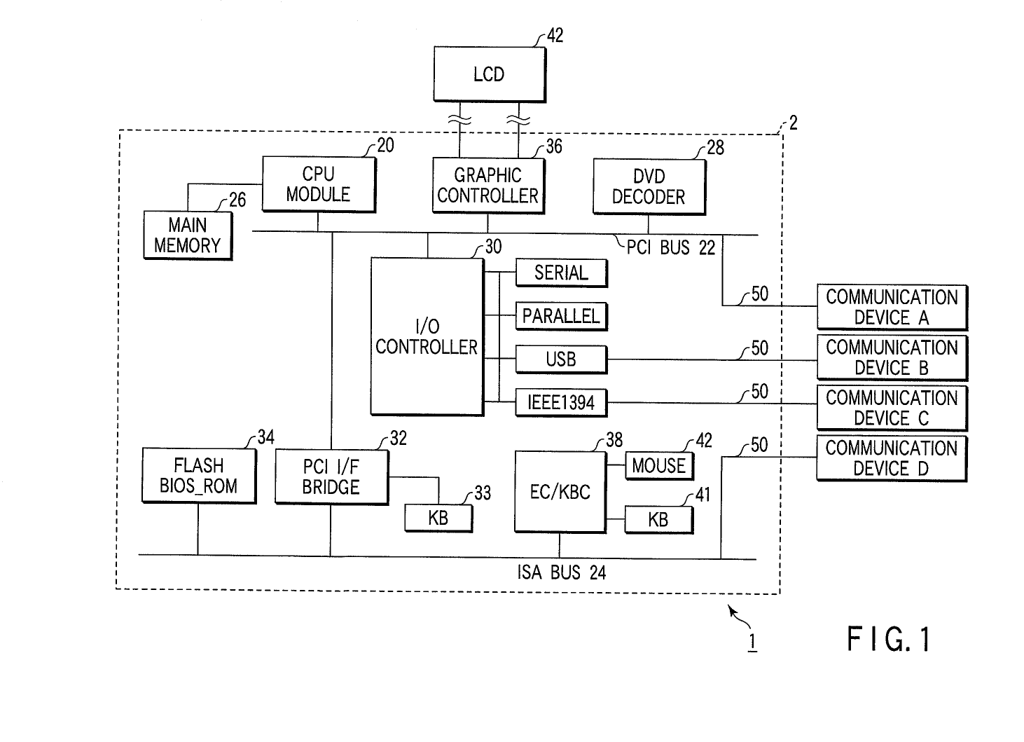

FIG. 1 is a block diagram showing a computer system comprising a communication-device switching control system according to the present embodiment.

In FIG. 1, a computer system 1 includes a CPU module 20, a PCI bus 22, an ISA bus 24, a main memory 26, a DVD decoder 28, an I/O controller 30, a PCI interface bridge 32, a hard disk drive HDD 33, a flash BIOS_ROM 34, a graphic controller 36, an EC/KBC 38, an LCD 42, and communication devices A, B, C, and D connected through ports 50 to a predetermined bus.

The CPU module 20 executes operation control and data processing of the entire computer system. A controller or the like for controlling the CPU, cash, and main memory 26 is mounted on the module 20.

The CPU module 20 executes operation control and data processing of a communication device switching control system which will be described later.

The main memory 26 functions as a main storage device of the present computer system. The main memory 26 stores an operating system, an application program as a processing target, and data and the like prepared on the basis of the application program.

An operation system (hereinafter called “OS”) Windows 95 (registered trademark) manufactured by Microsoft is developed on the main memory 26. The communication device switching control system 10 is constructed among a plug-and-play section 11 started by the OS, a registry 12, a communication device switching module 13 (described later), and communication devices A to D.

The I/O controller 30 is a gate array for controlling various I/O devices included in the body of the computer 1, and performs control concerning input/output of devices connected to various I/O connectors such as USB ports and the like.

The PCI interface bridge (PCI I/F) 32 is a gate array realized by a one-chip LSI. This PCI I/F 32 has a bridge function to connect the PCI bus 22 and the ISA bus 24 with each other and a function to control the HDD 68.

The flash BIOS_ROM 34 is a program-rewritable flash memory and stores a system BIOS. Note that the system BIOS systemizes a function execution routine for accessing various hardware in the present computer system.

The graphic controller 36 is an LSI having a drawing function which supports VGA (Video Graphics Array) (640 dots×480 lines), SVGA (800 dots×600 lines), XGA (1024 dots×768 lines), and the like.

The LCD 42 is a display device which displays images on the basis of control signals and image data from the graphic controller 36.

EC/KBC 38 is a characteristic part of the present invention, and it converts input signals from the keyboard 40 and a mouse 41 into bit strings, and transfers them to respective control sections.

Each of the communication devices A, B, C, and D is any of communication devices of a wireless LAN communication device, a wired LAN communication device, a Bluetooth device, a telephone line modem, a portable phone, and the like, and is connected with the PC body.

In the present embodiment, four communication devices are mounted or connected as described above. Needless to say, however, the communication device switching control system is effectively used for any electronic device such as a PC or the like, which mounts or connects two or more communication devices.

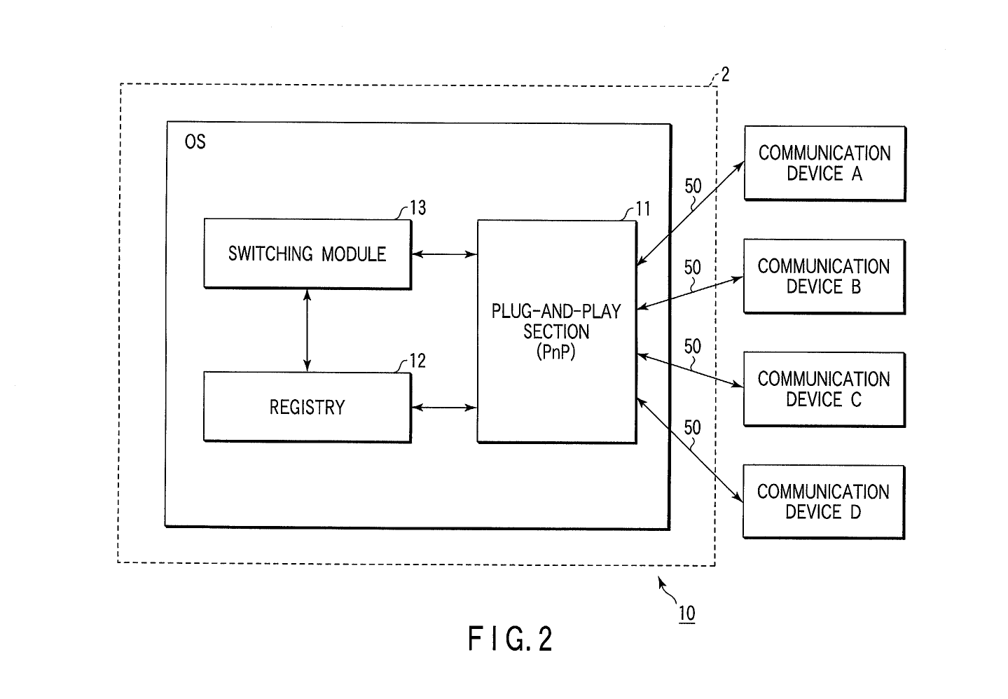

Next, the communication device switching control system 10 developed on the present computer system 1 will be explained with reference to FIG. 2.

FIG. 2 is a block diagram showing the communication device switching control system 10. The present communication device switching control system is constructed by a plug-and-play section 11, a registry 12, and a switching module 13.

(Plug-and-play Section)

The plug-and-play section 11 has a function to perform automatical incorporation and state of a device driver, i.e., plug-and-play when an expansion card, a peripheral device, or the like is connected to the PC. The plug-and-play section 11 checks the respective communication devices described above or other peripheral devices, which are connected at the time when the OS is started, and assigns I/O (input/output) addresses and IRQ (interruption signals) to them. Simultaneously, the section 11 simultaneously reads corresponding device driers, thus dynamically managing the hardware structure.

In addition, the plug-and-play section 11 can add/delete hardware by the plug-and-play function without stopping the function of the OS. The function of adding/deleting hardware to switch communication devices is one of features of the present communication device switching control system.

Further, the plug-and-play section 11 automatically executes restarting or the like of the computer if necessary in case where no device driver for a connected device exists in the library of the OS.

In general, the plug-and-play function is provided for a device using a USB bus, a device according to IEEE 1394 standard, a device using a PCI bus, and the like, in many cases, and is also a standard function included in an OS.

(Registry)

The registry 12 is a place for storing information concerning specification and environmental states of drivers for various devices such as communication devices and the like, and concerns their relationship with applications. When various properties and states are changed, information thereof is stored in the registry 12.

For example, if state information of the plug-and-play stored in the registry 12 is changed, the plug-and-play section 11 or the OS operates in accordance with the state after the change. Normally, management of the environmental states based on the information in the registry 12 is carried out by a routing table.

(Switching Module)

The switching module 13 is a mechanism for changing the states in the registry 12, based on a predetermined input instruction, and is a feature of the present invention. For example, the switching module disconnects all the connected communication devices or renders only a selected communication device operational. This module thus has a function to change the state concerning various communication devices in the registry 12.

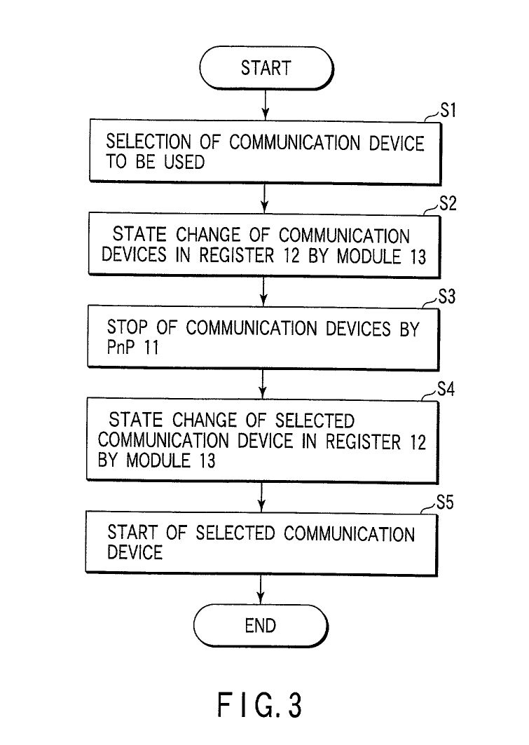

Next, the operation of the communication device switching control system constructed as described above will be explained with reference to FIG. 3. In the computer system 1, a “standard state” is defined as a state in which control of communication devices is carried out by a conventional method without operating the present communication device switching control system 10. Also, in the computer system 1, a “basic state” is defined as a state in which only one selected communication device is rendered operational.

FIG. 3 is a flowchart showing a procedure of switching from the standard state to the basic state, executed by the communication device switching control system.

In FIG. 3, at first, exclusive use of only the communication device A is inputted by a predetermined operation through a mouse, keyboard, or the like (Step S1).

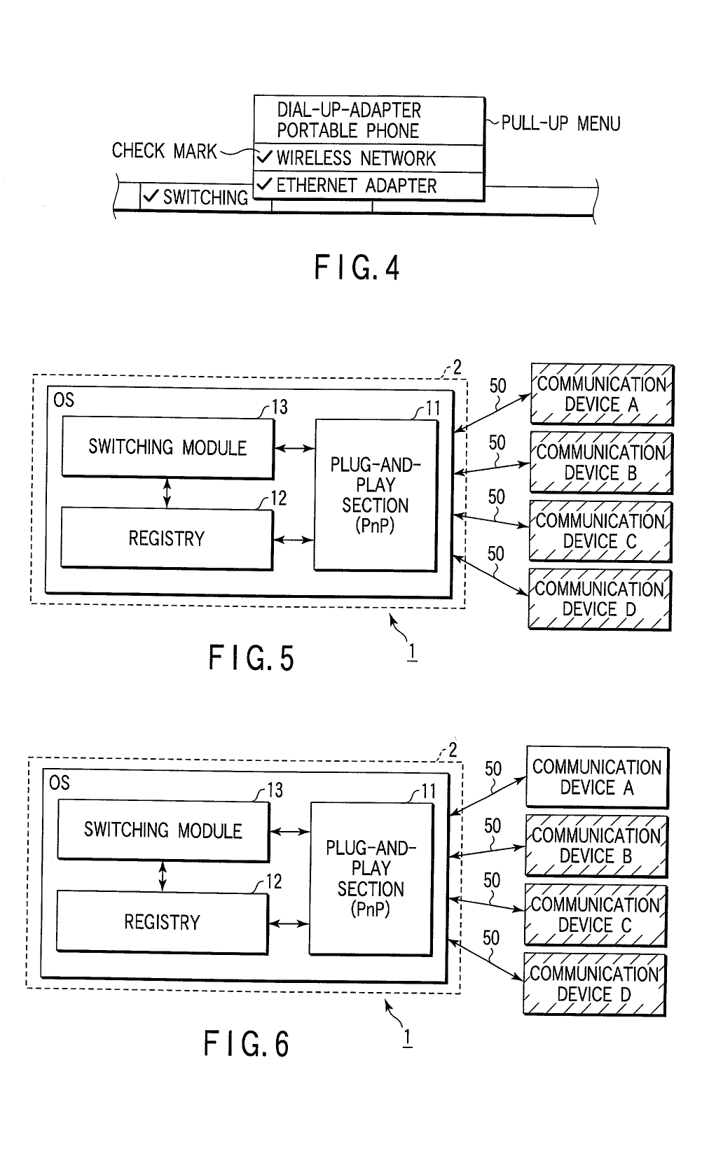

FIG. 4 is a view showing an example of selecting a communication device by using the GUI (Graphical Use Interface).

As shown in FIG. 4, for example, a user can select a desired communication device using the mouse. When a cursor is set on a “switch” icon displayed on the LCD 42, connected communication devices are displayed in the form of a pull-up or pull-down menu. The user selects (clicks) a desired communication device on the menu, thereby to check the communication device to be used. The menu closes and the selection operation is thus completed.

The menu shown in FIG. 4 has a structure in which all communication devices whose states are written in the registry 12 are displayed.

Also, it should preferably be arranged such that the communication device selected in step S1 is expressed as an icon displayed in a task tray on the LCD 42. In this case, the structure may be arranged such that the display form of the icon is changed when the selected communication device is operating.

Next, the switching module 13 changes the states of the communication devices in the registry 12 in response to the operation of the communication device selecting operation (step S2). Namely, the switching module 13 switches all usable states with respect to the communication devices in the registry 12 to stopped states.

Next, the switching module 13 transfers the new status in the registry 12 to the plug-and-play section 11. The plug-and-play section 11 stops related functions (e.g., TCP/IP or the like) provided by each communication device (step S3).

In addition, in accordance with the stop of the related functions, the routing table is initialized. This is the reason why the basic state might not reflect the communication information in the standard state.

FIG. 5 shows a state in which each of the communication devices A to D is stopped by the function of the plug-and-play section 11. Oblique lines in the figure indicate that the communication devices are stopped. In addition, the message that each of the communication devices A to D is stopped is displayed on the LCD 42 under the stopping. The user can see that each of the communication devices A to D is temporarily stopped.

As shown in FIG. 5, after all the communication devices A to D are stopped, the switching module 13 switches the stopped state with respect to the communication device A selected in step 1 to the usable state (step S4). In addition, in accordance with the change of the state of the device A, the routing table manages the communication device A exclusively.

Note that, the procedures in step 2 and 3 may be omitted. In this case, though the routing table is not erased initialized, the communication device A can be used exclusively.

The plug-and-play section 11 starts only the communication device A, in response to the state of the communication device A being usable (step S5). At the same time the device A is started, the functions provided on the communication device A are started. That is, the plug-and-play section 11 automatically sets the communication function of the communication device A, thereby to enable the communication device A.

FIG. 6 shows a state in which only the communication device A is rendered usable by the function of the plug-and-play section 11. Oblique lines in this figure express that the communication devices are stopped.

As shown in FIG. 6, the present computer system 1 is in the basic state in which only the communication device A is usable. Therefore, a user can exclusively operate the communication device A.

As has been described above, in the switching control system according to the present embodiment, communication devices to be used are attached and detached by utilizing a standard function, i.e., the plug-and-play function provided by an OS. Therefore, it is necessary to detach communication devices to be used, and thus, unnecessary extra labor is not required for users.

Also, switching between communication devices is operated through a very simple interface. Hence, the user-friendlyness handling ability of computers or the like can be improved.

Thus, according to the present control system, users can carry out switching between electronic devices easily at low cost without making difficult and complicated states, so that the user-friendlyness of computers or the like can also be improved.

In addition, for example, a wireless LAN and a Bluetooth device sometimes use close frequency bands, and may interfere with each other if both are used simultaneously. The present communication device switching control system is particularly useful when exclusively using any one of the communication devices in this kind of environment.

In the above description, the present invention has been explained on the basis of an embodiment. However, a person skilled in the art can think up various modifications and changes within the scope of the concept of the present invention. Such modifications and changes are considered to be also within the scope of the present invention. For example, various modifications are possible without changing the subject of the present invention.

The present communication device switching control system is constructed in a structure in which the communication functions of all communication devices are stopped in switching between communication devices. Therefore, in some cases, all inputs may be locked and users can not operate the OS. In this case, the structure may be arranged so as to display a message “Now Switching” while the devices are stopped. Alternatively, the structure may be arranged so as to make a report saying “Now Switching”.

In this structure, users can easily understand that they can not operate the system. Users thus do not feel stress from the temporary stop of the communication functions or the locked input.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication device switching control system comprising:
a plurality of communication devices;
a memory configured to store operational state information concerning each of the plurality of communication devices;
a selection device configured to select a desired one of the plurality of communication devices;
a state information administrative device configured to set up usable with respect to operational information of said selected communication device, and to store the setting operational state information to said memory; and
a controller configured to control the selected communication device, in accordance with the setting operational state information stored in said memory.

2. The system according to claim 1, wherein said controller temporarily stops each of the plurality of communication devices and thereafter starts the communication device selected by said selection device, if the setting operational state information is stored to the memory.

3. The system according to claim 2, further comprising a notification device configured to notify a user that each of the communication devices is temporarily stopped while each of the communication devices is temporarily stopped.

4. A communication device switching control method comprising steps of:
selecting a desired one of a plurality of communication devices;
setting up usable with respect to operational information of the selected communication device;
storing the setting operational information to a memory; and
controlling each of the communication devices in accordance with the setting operational information in said memory.

5. The method according to claim 4, wherein, after each of the communication devices is temporarily stopped in control of each of the communication devices in accordance with the setting operational information, only the selected communication device is started.

6. The method according to claim 5, wherein while each of the communication devices is temporarily stopped, a message that each of the communication devices is temporarily stopped is offered to a user.

7. A communication device switching control system comprising:
a plurality of communication devices;
a memory configured to store state information concerning each of the plurality of communication devices;
a first computer code device configured to select a desired one of the plurality of communication devices;
a second computer code device configured to set up usable with respect to operational information of said selected communication device, and to store the setting operational state information to said memory; and
controller for controlling each of the communication devices, in accordance with the setting operational state information stored in said memory.

8. The system according to claim 1, wherein said controller temporarily stops each of the communication devices and thereafter starts the communication device selected by said first computer code device, if the setting operational state information is stored to the memory.

9. The system according to claim 2, further comprising a third computer code device configured to notify a user that each of the communication devices is temporarily stopped while each of the communication devices is temporarily stopped.
